(19) United States
(12) Patent Application Publication
(10) Pub. No.: US 2003/0213841 A1
(43) Pub. Date: Nov. 20, 2003

(54) Method for verifying and authenticating initially named payee of negotiable instruments

(76) Inventors: Stanley M. Josephson, Dallas, TX (US); Thomas S. Stephens, Addison, TX (US)

Correspondence Address: SEYFARTH SHAW, 55 EAST MONROE STREET, SUITE 4200, CHICAGO, IL, 60603-5803, US

(21) Appl. No.: 10/063,796

(22) Filed: May 14, 2002

(51) Int. Cl. G06F 17/60

(52) U.S. Cl. 235/379

(57) ABSTRACT

A negotiable instrument payee authentication and identification method in which payee identification information is printed onto the negotiable instrument and maintained in a computerized database. When the payee presents the negotiable instrument for cashing, the identification information contained within the database is recalled and compared to the identification information contained on the printed negotiable instrument to ensure conformity.

### BACKGROUND OF THE INVENTION

The present invention relates generally to a method for validating negotiable instruments, such as bank checks, when presented by payees for encashment by tellers or cashiers. More specifically, the present invention relates to a method for authenticating and verifying a payee's identity, which is pre-printed on a negotiable instrument.

Check fraud is one of the largest challenges facing financial institutions and businesses today. There is an increasing incidence of check fraud perpetrated against banks, other financial institutions and check cashers. This is due in large part to the introduction of technology that allows conventional payee information on a bank check to be easily altered or manipulated. Using low cost, high-resolution copiers and laser printers, the alterations can be done in such an exacting manner that they are virtually impossible to detect by current visual inspection conducted by bank tellers or other check cashers.

The majority of these checks are sent to the payees home address through the U.S. mail on a monthly cycle and are predominately payroll, social security, annuity or welfare checks. Generally, they are of relatively low monetary value, but the cumulative effect of the fraudulent transactions is costly. Furthermore, a large number of these checks are payable to payees that do not have bank accounts (the “unbanked”). A large percentage of these mailed checks are stolen, altered and cashed at banks or other check cashing facilities to the detriment of the payee, the issuer and the banking system.

According to an American Bankers Association (ABA) survey of large banks in year 2000, about 1.2 million fraudulent checks were presented daily, costing United States corporations $12-$16 billion a year and costing each of the large United States banks an average of more than $34 million a year. Statistics are not currently available to accurately determine the percentage of those losses that can be attributed to stolen and altered checks, but most industry experts indicate that it is one of the more significant reasons for the bank losses.

Commercial banks, as well as other check cashing services, have thus instituted various manual procedures and some limited forms of automated systems designed to determine if the presenter of the check is the true payee named on the check. However, these methods and procedures are not standardized from bank to bank, thus leading to their underutilization due to lack of uniformity. Most rely on superficial visual comparisons of the printed payee's name to the endorsement signature, often combined with visual verification with a physical form of identification such as a driver's license or other picture identification. Under this procedure, stolen and subsequently altered checks are easily cashed due to the ease of modifying the payee's name and/or dollar amount on the check itself. Unfortunately, in most instances, the theft is not discovered until bank clearinghouse procedures are conducted a day or so later or even some weeks later when the check issuer is notified of the theft.

In response, many commercial banks have recently begun implementation of various types of fraud detection computer systems that incorporate systemic logic to determine if a presented check has the statistical probability of being fraudulent. This is generally accomplished by building historical behavioral profiles of the payee, utilizing artificial intelligence techniques, or various classification systems. While these methods are generally considered successful in identifying certain types of fraud, such as check kiting which is the ability to gain access to deposited funds before they have been collected from the institution on which they are drawn. These methods are still unable to recognize and prevent fraudulent activity at the initial step in the check processing chain which occurs at the point of teller presentment because they can only detect fraud after the fact.

Corporations, generally bearing the brunt of the financial loses, have adopted other “after the fact” methods of fraud detection that rely on electronic comparison between the issued check and the paid returned check. However, this method of verification is after-the-fact, wherein differences between the issued check and the already paid check create an exception that is examined after the check in question has been retrieved and the determination to accept or return the check is already complete. These popular comparison systems are called account reconciliation programs (ARP) or positive pay systems and have been in use for many years to detect fraud associated with altered check amounts, duplicate and unpaid checks.

More recent extensions of the ARP process allow a comparison of the payee name printed on the check to that of the payee name when the check was initially issued. This process can then detect alterations of the payee name. However, once again, this detection is after the check was already paid.

As a result of theft and subsequent fraud previously described, some commercial banks have instituted policies that restrict check cashing to only those persons that are customers of their bank. This then causes the “unbanked” individuals, comprising approximately 27% of the U.S. adult population, to cash the check at a check cashing facility that may charge as much as 10% of the checks face value for the service.

There have been attempts to develop processes in which books of checks are printed showing personalized information in addition to the standard name and address information of the account holder. This information usually is the account holder's drivers license number, the date the account was opened, home telephone number, and the like. Additionally, check printers have developed various types of safety features incorporated in blank check stock that discourages photocopying and alteration; however, even with these measures the incidence of check fraud continues to increase.

Some check book printers have further invested in the technology to print a scanned picture of the account holder on the face of the check similar to pictures shown on a credit card. However, all verification attempts thus far only address the payer's identification. The present invention overcomes this limitation by, for example, verifying the payee's identification.

There also exists attempts to thwart fraud that have been designed to detect altered and stolen checks at the time the paying bank pays the check, which normally occurs during the banks nightly Demand Deposit Accounting (DDA) processing. This process usually includes capabilities to detect lost or stolen checks in the same manner as stop payments requests of a specific check are detected. If the check's serial number is flagged within the DDA system, then the system will detect and identify that check once it reaches this stage of processing. However, a limitation of this process is that it is not designed to detect payee name or check amount alterations at the point of initial presentation to a teller. The present invention overcomes this limitation by, for example, verifying the payee's identification and comparing the amount to be paid with the originally issued amount.

The present invention overcomes the disadvantages and/or shortcomings of known prior art check validation and payee identification processes and provides significant improvements thereover.

### BRIEF SUMMARY OF THE INVENTION

As discussed herein, it is to be understood that emphasis on the terminology of bank check is not to be considered limiting, but rather an exemplification of the present invention. The present invention is intended to be utilized with all types of negotiable instruments wherein it is desirous to authenticate and verify the identity of a payee.

The present invention provides a method to access and print additional payee identification information on a check in human-readable and/or machine-readable formats. Alternatively, the additional payee information may be accessed for display or audio means from local or remote databases accessible through telephones, online computer terminals or voice response devices. The present invention allows the teller or other check cashers (for purposes of this application, the collective term “teller” shall be used for all types of persons or businesses that cash checks or otherwise accepts check endorsements) to quickly and positively determine if the individual attempting to cash the check is the legitimate payee, thereby overcoming the shortcomings of current fraud detection procedures.

The present invention captures and stores payee identification information within an accessible database system. For example, this additional information may be a complete digitized image of the payee's driver's license, an employee's identification badge, a picture of the payee, and the like. Then, the present invention produces checks printed with both the conventional check information as well as additional identification information stored within the database.

In addition to the human readable information displayed on the check, other forms of machine-readable coded information may be incorporated onto the check at the time of printing that can be read by bar code readers, magnetic ink character recognition readers and other types of optical character recognition devices. This machine-readable data provides a means of secure access to the storage databases to determine authenticity of the payee since the original identification material has previously been scanned and entered into databases. When the payee wishes to cash the check at a bank or other check cashing facility, the payee endorses the check and presents it along with the required physical identification to the teller.

As such, by comparing the original identification information stored within the database to the identification information on the check, the computer system and/or teller will be able to detect any type of altercation or modification, thus alerting the teller to potential fraudulent activity.

It is an object of the present invention to provide a means of positive identification of the payee of a check.

It is a further object of the present invention to reduce bank, corporate and government losses due to fraud associated with stolen and altered checks.

It is a further object of the present invention to reduce the incidence of checks stolen from the mail for the purposes of payee and/or amount alteration.

It is still a further object of the present invention to implement a system, which minimizes corporate and bank overhead at teller locations by reducing required computer hardware.

Another object of the present invention is to provide a more efficient method for tellers to authenticate checks.

### BRIEF DESCRIPTION OF THE SEVERAL VIEWS OF THE DRAWINGS

The preferred embodiment is herein described in detail with references to the drawings, where appropriate, wherein:

FIG. 1 is a schematic drawing illustrating the equipment components of the preferred embodiment situated at a typical check production entity's information capture site and database maintenance locations.

FIG. 2 is a schematic drawing illustrating the equipment components of the preferred embodiment situated at the check production entity's check printing locations.

FIG. 3 is a schematic flow chart illustrating the preferred embodiment's process of capturing information, maintaining and updating of the payee information databases.

FIG. 4 is a schematic flow chart illustrating the preferred embodiment's process of the check generation utilizing the payee information databases.

FIG. 5 is a schematic drawing illustrating the preferred embodiment's equipment components situated at a typical teller station.

FIG. 6 is a schematic flow chart illustrating the preferred embodiment's process of operational procedures performed by tellers.

### DETAILED DESCRIPTION OF THE INVENTION

The preferred embodiment of the present invention provides a method to capture payee identification information, store and integrate such information into databases, and then print either selective portions of or the complete identification information on a check during check generation. When the payee presents the check for cashing or other endorsement, the payee identification information stored within the databases is recalled and compared to the information contained on the check in order to verify payee identification and/or check amount.

At the payee identification information capture location, the preferred embodiment includes a digital scanning means or digital photo capturing means for capturing pictures of the payee and digitizing images of additional payee information provided by the payee, such as employee badges, keyboard devices that allow manual entry of alphanumeric data and to enter instructions that will allow linkage of the information to accounts payable and payroll databases for each intended payee. This information is then stored in a database location, which is preferably connectively interfaced with other databases through conventional data transmission means. Further preferably, the stored information is maintained with a backup regimen to ensure data integrity and consistency. Alternately, the databases can be setup wherein the information is maintained in a striped configuration among numerous and independent locations, wherein the destruction or corruption of one location does not destroy all of the data within the database.

Within the preferred embodiment of the present invention, the teller locations equipment configuration will be minimal. Preferably, there will not be a requirement for any additional equipment that is not already installed at conventional teller locations and currently in use for other purposes. A telephonic or a terminal device, such as a personal computer with an associated monitor, keyboard and networking connectivity, will be maintained in the event that the teller requires access to the identification database to retrieve information not present in human readable form that was printed on the check. Alternately, other reading devices such as bar code readers, optical character recognition (OCR) readers, and magnetic ink character recognition (MICR) devices may be interfaced to the terminal device to facilitate automated or computerized comparison of the presented check information to the stored identification information contained within the database.

In the preferred embodiment of the present invention, the teller is presented a check by an individual, which is supposedly the payee. The individual presents the endorsed check to the teller along with the appropriate conventional identification materials such as a driver's license or an employee badge. This information is visually compared to the payee identification information that is printed on the check to determine authenticity. If the comparison fails, the payee's endorsement fails. If the comparison is valid, then the check's endorsement is accepted and consideration is given to the payee.

In an alternate embodiment, the presented check's printed payee identification information is in machine-readable data rather than, or in addition to, human-readable information as previously described. This machine-readable data can take the forms, for example, of magnetic ink character recognition fonts, optical character recognition fonts, or bar coded fonts. This machine-readable data allows the teller to directly enter that information via the terminal device though means of an interfaced reader/scanner device such as magnetic ink character recognition, optical character recognition and bar code readers, for example. Additional information inputs derived from the materials presented by the payee, such as a driver's license number, may also be scanned or key entered. The terminal device then accesses the storage database, which maintains the original payee identification information, which in turn retrieves the identification information and displays such information on the attached monitor screen for verification of the presented identification material. In addition to the foregoing, the amount of the check may also be key entered for verification purposes. The screen display may show additional alerts and warnings that are applicable to the specific check, such as, a duplicate check has been presented, the check amount does not match the issued check amount, the check has previously been paid, the check was never issued or was voided prior to issue, or the check was reported as stolen.

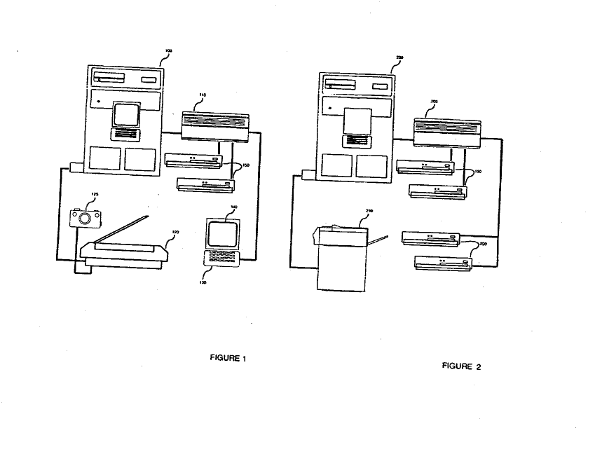

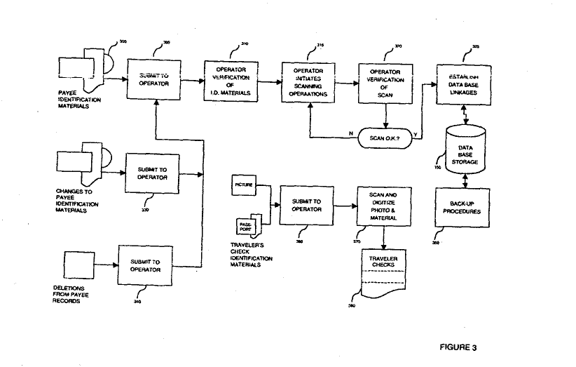

Referring to FIG. 1, the preferred equipment components located at the identification information capture site and database maintenance locations are depicted. Preferably, a central computer system 100 along with a cable or a communications port connected controller 110 comprise the main components to which other ancillary devices are interfaced. The interface may be made through communication ports or internally connected by cable to the computer controller 110. Ancillary devices may be one or more digital scanning devices 120, digital cameras 125, keyboards 130, screen display monitors 140, or mass data storage devices 150. The scanned digitized materials are preferably viewed by the operator prior to acceptance using the screen display terminals 140. Upon acceptance and validation by the operator, the applicable programs and linkages are initiated via keyboard 130 manual key entries. The digitized images of the scanned materials are then transferred by electronic means to be stored on the mass data storage devices 150. It should be noted that other types of compatible peripheral devices might be included in this configuration that are capable of performing the same or similar functions.

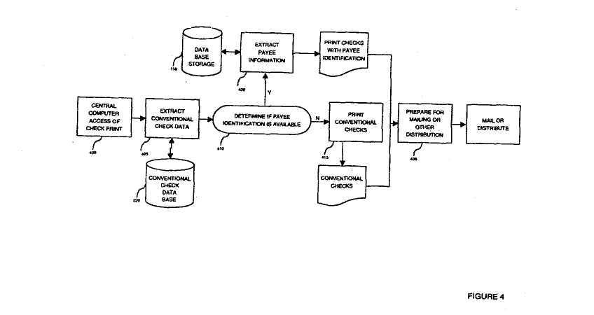

Referring now to FIG. 2, which illustrates the preferred equipment components situated at the check printing location, which may also be physically housed in the same location as that of the central computer 100 systems, and may utilize the same central computer. For clarity purposes, this central computer system is identified as 200. Once again, a central computer system 200 is the primary component of the configuration. Peripheral devices interfaced via cable or communication connection from the central computer controller 205 include laser printing devices 210, a mass data storage device 220 containing the necessary information to produce a conventional printed check, and a mass data storage device 150 which contain the digitized images of the scanned materials. Alternately, the mass data storage devices 150 and 220 may be combined into a single data storage device 220. Still alternately, the information contained on the mass storage devices 150, 220 may be maintained at numerous locations, with replications maintained among the numerous mass storage devices 150, 220 in order to ensure data accuracy and redundancy. One or more computer programs reside within the memory of the central computer 200 that are designed to generate, format and print checks and check stubs from the information stored within the mass data storage devices 150, 220 which, in addition to the conventional check information and check stub information, may also include printed digitized images of the payee information derived from the previously scanned payee identification information which have been stored within the mass data storage device 150. It should also be noted that other types of compatible peripheral devices might be included in this configuration that are capable of performing the same or similar functions. Alternately, this information may also be in machine-readable format, such as magnetic ink character recognition fonts, optical character recognition fonts, or bar coded fonts.

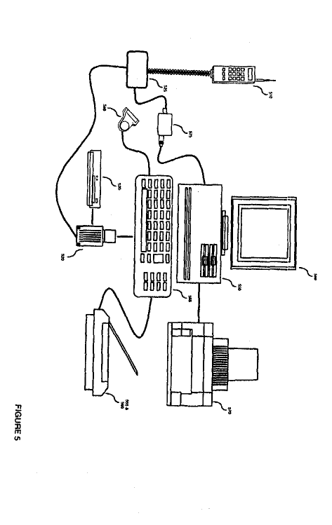

Referring now to FIGS. 1 and 3, which detail in flow chart format the preferred embodiment's step-by-step operational process performed at the paying entity's information capture location that includes the initial capture of payee identification information and the subsequent maintenance and updating of the payee identification information stored on the databases using the preferred system components described above. A payee who will receive a check submits specific identification materials, which may include materials such as a driver's license, a photograph, a passport, an employee badge or other forms of descriptive information that will allow positive identification of the payee when viewed by the systems operator 300. The system operator verifies 310 that the materials submitted properly identify the payee when such materials are subsequently printed on a paper check, which preferably includes the payee's printed name. Alternately, a digital picture of the individual may be taken 305 and included as appropriate identification material, or other identifiable information such as biometric data. The operator then executes one or more programs 315 using the preferred embodiment's keyboard input 130 to initiate a scanning function that uses a digital scanning device 120 wherein the submitted materials are scanned, thus generating digitized images of the materials. The operator verifies 320 the quality of the digitized images displayed on the screen 140 and, if acceptable, the operator then keys computer instructions 325 using the keyboard 130, which causes an electronic linkage to be generated between the payee's digitized image materials and the payee's payment information which was previously stored on the mass data storage device 150. This linkage may be facilitated by entry of an employee number, the payee's name, an account number, or the like. Alternately, this process may be automatic wherein a computer device verifies if the quality of the digitized images is acceptable, and, if so, automatically provides the linkage between the payee's digitized image and payment information. These functions are preferably performed under strict security controls in order to maintain the integrity of the system.

A process 330, similar to that described above, allows changes and updates to the stored identification materials, such as name changes, driver's license address changes, and the like. As such, the preferred embodiment of the present invention remains dynamic and can thus be constantly updated with new payee identification information. There is also preferably a deletion process 340 to remove the identification information from the stored information databases when a payee is terminated, resigns or is no longer eligible to receive a check, as an example. The information residing on the mass data storage device 150 is preferably conventionally backed-up 350 and maintained under stringent security procedures.

A similar process to the preferred embodiment described above may be used in the preparation of traveler's checks or other negotiable instruments. Unlike payroll checks and the like, traveler's checks are purchased by the payer from a traveler's check provider and are commonly used for the purchase of goods and services in lieu of personal checks. The payer currently completes the payee information at the time the traveler's check is used. This type of check is also subject to fraudulent activities. However, as a deterrent to fraud, the preferred embodiment of the present invention allows the picture of the payer and/or the payer's identification information 360 to be scanned, digitized 370 and printed 380 on the traveler's checks, thus providing a positive means of identification to the recipient when the traveler's check is negotiated.

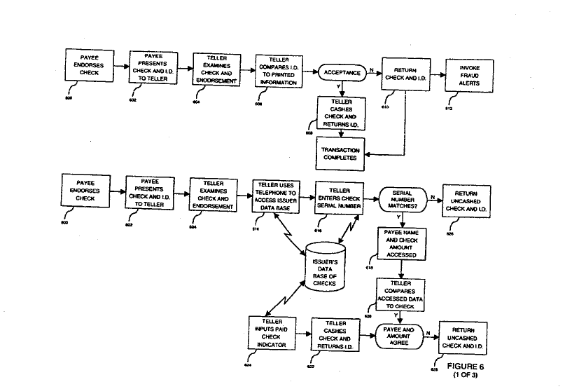

Referring to FIGS. 2 and 4, which illustrates by means of a flow chart the preferred step-by-step process whereby checks are printed that contain the payee information derived from the payee information database that has been incorporated with the conventional check and check stub information. At a minimum, the printed check information will include conventional information, in human-readable form, such as the date of the check, the payee name, the check amount in numerals and in words, the check serial number, the bank name and address that the check is drawn on, and the signature of the issuer. Alternately, the check may also contain machine readable MICR information in conformance with American Bankers Association (ABA) published standards (ABA Publication 147R3—The Common Machine Language) that includes, for example, the routing/transit number of the paying bank, the account number of the issuer at the issuer's bank, and the check serial or reference number. The MICR line information may be printed at the same time the check is printed or it may have been preprinted at the time the check forms were initially manufactured. Further alternately, the information printed may be in machine-readable format, such as magnetic character recognition fonts, optical character recognition fonts, or bar-coded fonts. In the preferred embodiment of the present invention, the mass data storage device 150 containing the stored payee identification information is accessed by the central computer's circuitry during the conventional process of check printing 400. The conventional check information is extracted 405 from the information stored on the mass data storage device 220. The program then determines if payee identification information is available for the payee whose check is in the process of being printed 410. If not available, the conventional check format is printed 415 without any payee identification information. If the payee identification information is available as determined by accessing the mass data storage device 150, that digitized identification information is extracted, formatted and printed on the check 420 in addition to the conventional check contents. The printed payee identification information may take other forms such as coded information, machine readable information, watermarked information or merely a printed logo or icon indication that alerts the teller to access alternate databases or that additional steps must be performed to verify the authenticity of the check's payee and/or the check amount. Furthermore, it may be desirable to only print selected portions of the stored payee identification information, or to print the complete payee identification information. Alternately, upon the creation and printing process of the checks, the printing process creates a unique identifier of the database location on the check, thus denoting to the teller the location of where the payee identification information may be retrieved when the check is presented for cashing. This unique database location identifier may be, for example, a human-readable icon, logo, telephone number or Internet web site address which denotes the issuing bank's information or payee information database location. Still alternately, this unique database location identifier may take the form of machine-readable fonts.

Preferably, high-speed laser printers are used for check printing purposes. Alternately, other types of printing output devices may be utilized. The printed checks, whether they contain the payee identification information or not, are then prepared, via conventional methods, for mailing or distributing via other methods to the payees 430.

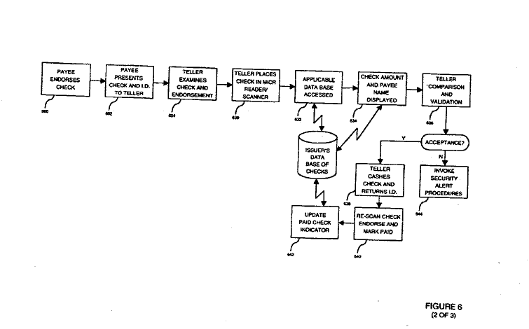

Referring now to FIG. 5, which illustrates the preferred equipment components situated at teller stations. First, it must be appreciated that there are a wide variety of available communication and input/output devices that will provide the necessary capacity, connectivity and functionality envisioned for use in the preferred embodiment of the present invention. These devices range from merely a telephone with an integral keypad to a computer system interfaced with a peripheral device. Therefore, while only preferred and alternate embodiments of the various equipment components will be discussed below, it shall be obvious that other devices may be substituted or added to the configurations that are specified herein.

The preferred embodiment of the present invention consists of a computer controlled terminal 550 interfaced through cable connections, with one are more scanner devices 555 and one or more imaging devices 560. These devices are capable of capturing the front and back digital images of a check. Additionally, keyboards 565, hard copy printing units 570, high speed network connectivity 575, and screen display monitors 580 may be in operable connection with the terminal 550. Incorporated in the terminal 550 is sufficient intermediate memory capacity for storage of the necessary programs to allow the terminal 550 to operate as a stand alone device, or alternately, as a device to receive downloadable issued check data from the check issuer's databases and to perform a data transmission of cashed check information to update the check issuer's database.

In an alternate embodiment of the present invention, a teller may not require the use of any equipment. The teller will perform the payee verification procedure by visual inspection of the payee identification information printed on the check as compared to that same physical identification information supplied by the individual attempting to present an endorsed check, such as presenting photo identification.

Another alternate embodiment of the present invention includes a telephone 510 that allows the teller to use touch-tone entry via keypad or entry by audio command of the presented check's serial number. This, in turn, will access, through data transmission means, the appropriate database of issued check information provided by the check issuer. If a match is found between the entered check serial number, then the check amount and payee's name may be displayed or spoken electronically by means of an audio response system or visual display device for teller verification. Upon satisfactory verification, the teller then responds by key entry or voice entry to indicate the check will be cashed and the issued check database will be updated to reflect that the check has been successfully cashed. As such, that specific check serial number is now void for future presentments. If a matching serial number cannot be found on the database or a match is made but the check has been flagged as lost, stolen or previously paid, an appropriate response is provided to alert the teller that there is a possibility of a fraudulent check being presented.

In an alternate embodiment of the present invention, the telephone 510 key entry or voice entry is replaced by a MICR reader/scanner 520, interfaced to the telephone connection 525, that has the circuitry to read the data printed on the check's MICR line, to access a central computer host processor and to perform data transfers to and from the central computer. This standard information consists of the paying bank's routing/transit number, the account number at the paying bank and the check serial number. This data provides sufficient keys to locate the appropriate issuer's database and to search that database for a matching check serial number. Alternately, other similar devices may read or scan machine readable data comprised of different fonts and media 540 that were printed on the check in a coded form, for example optical character recognition (OCR) or the various bar code configurations that will allow automated reading of the data printed on the check when read or scanned with a compatible reader or scanning device which thus denotes the payee identification information database location. Still alternately, devices can be utilized to read transparent or watermark data embedded into the check.

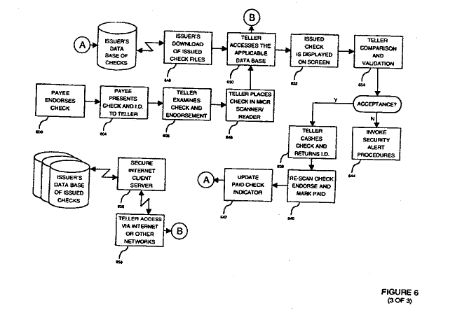

Turning now to FIG. 6. which depicts step-by-step block diagrams to illustrate operational procedures performed by the tellers utilizing various equipment configurations that are uniquely enabled by the present invention. As previously discussed, the simplest form of the present invention is an embodiment whereby the teller visually examines the check that has been presented by an individual that is presumed to be the payee. The payee first conventionally endorses the back of the check 600 and presents the check to the teller along with the supporting identification materials 602 as proof that the individual is the rightful payee. In this illustration it is assumed that the check includes the printed digitized images of the supporting identification materials. The teller first visually reviews the check in the conventional manner and in conformance with bank policies which may include determining if the date is stale, is properly signed by the issuer, properly endorsed by the payee, and the like 604. The teller than further visually compares the printed digitized images of the supporting identification materials to those same materials presented by the individual attempting to present the endorsed check 606. If the teller confirms that the comparison is accurate, the check is accepted in return for consideration 608 and the transaction is complete. If the teller is unable to confirm the comparison, the check is not accepted 610. Under the latter circumstance, the teller may invoke security procedures and retain the check and materials as evidence of the attempted fraud 612.

An alternate embodiment of the previous description includes a telephone 510 that allows the teller to connect and access a database of issued checks and to perform additional verification functions. This is preferably accomplished using strict security and password control. Under this scenario, the check may contain the payee's printed identification information or only a printed indication that the check may be authenticated using the issuer's database of issued checks containing payee identification information. The printed indicator may consist of only a telephone number, icon, Internet web site address, logo or symbol. Depending upon the content of the printed information on the check, the teller may conduct the same procedure set out in the previous example 600-604 with the addition that the telephone is used to make connection to a database of issued checks applicable to that specific check issuer 614. The teller may manually key enter the check serial number or speak the number, depending on the type of data entry system employed. The database is searched to locate the matching check serial number 616 and if found, the issued check amount and payee name are audibly provided to the teller via the telephone connection 618. If the telephone is equipped with an audio-visual device, the applicable information may be displayed. The teller compares the response to the amount and payee name on the check 620. If correct, the check endorsement is accepted 622 and the transaction is complete. The teller then inputs, via a key entry or voice entry, an indication that the check has been cashed 624 in order to update the database to reflect the status of the cashed check. If a match is not found, however, generally indicating that the check was never issued or the date of issue has exceeded a time limit set by the issuer, the check is not accepted 626. In the event that a match is found, but the payee's name is incorrect or an indicator was placed on the check record in the database that denotes a duplicate check, i.e. one using that same check serial number that was previously cashed, the check was voided prior to issue or the check was reported as lost or stolen, the check is not accepted and the teller may initiate procedures that alert the authorities of the possible fraud 628 attempt.

Yet, another alternate embodiment of the present invention utilizes additional devices that improve teller data entry accuracy and productivity. These devices are generally categorized as scanners and can be connected directly to a telephonic device or computer system. As previously discussed, the presented check may or may not include the printed payee's identification information but includes a printed indication denoting that the check is qualified for issued file access and verification. The teller performs the same authentication procedures as previously described 600-604. However, in this embodiment, the MICR information on the bottom of the check is read by the scanning device rather than key or voice entry by the teller. These devices have the functionality to validate the MICR information as to the quality and accuracy of the data read and can perform certain calculations to insure that the length and content of certain fields are correct. The combination of the routing/transit field and the account number field generate a unique key that can access a plurality of databases of issued checks from many different issuers and locate the proper database for access and identification information retrieval. The teller places the check in the scanner 630 and the device makes the connection to the appropriate database 632 under comprehensive security and password controls. The check's MICR serial number is used to search the database for the corresponding issued check. When found, the check amount and payee name are displayed on the display screen on the device 634. The teller validates the information shown as compared to the physical check 636, if correct, the check is accepted 638. After which, the teller confirms the transaction by once again scanning the same check which may then place an endorsement or stamp a “paid” notation on the check 640. This action also updates the issued check record on the database marking it as paid and appending to the record the date, time, teller location and teller identification, for example.

Database software executed by the issuer may periodically extract the paid issued check records for use in other applications such as account reconciliation programs (ARP) and positive pay programs. As in the previously discussed embodiment, if a match of check serial number is not found or other exception conditions are noted, the teller may institute procedures to alert security to the possibility of fraud 644.

In another alternate embodiment of the present invention, other scanner devices may be employed that can read and/or scan other types of media and fonts, such as OCR and bar code, for example. The teller and database access operations described above will be identical, with the exception that the check will contain printed OCR or bar code information in addition to the standard MICR information. Other data elements may also be included in combination with the other fonts that allow valuable ancillary capabilities to be performed using the issuer's paid check records for example including a code that gives the ability to signal the teller that the check may be truncated, i.e. not sent forward for entry into the check clearing process, and to then generate an electronic check record that will subsequently be debited to the issuer's bank account electronically. Since many of the advanced models of scanners have the ability to digitize and store the front and back images of the presented check for subsequent research purposes, many other similar types of check truncation opportunities will be enabled under the present invention.

Yet another alternate embodiment of the present invention provides the ability to operate in both off-line and on-line modes. This equipment configuration takes advantage of the equipment that is already in use in most high volume teller operations and is consistent in functionality with the majority of installed teller platforms. The primary component is a computer controlled terminal (i.e., a personal computer) with cable and/or communication connections to a variety of peripheral devices which may include reader/scanners, imaging devices, keyboards, high speed modems, external storage devices and screen display monitors. The computer terminals may also be networked to provide the same interactive capabilities to a large number of tellers and/or databases. The teller operations in this environment are similar to those previously described 600-604; however, there are several significant functional differences. In this embodiment, issued check information may be downloaded to the teller's computer terminal 660 which then provides rapid access and retrieval. The teller, as in the previous descriptions, accesses the issued check information by key or audio entry of the presented check's serial number 662 or other unique identifier, or by using the scanner device. This configuration includes the ability to display a complete picture of the issued check, front and back, as digital images when the matching serial number of the presented check is located. The teller, or automated computer system, then compares the image to the physical check 664 to make the determination as to the authenticity of the check.

It is envisioned that check issuers would have the opportunity to transmit their daily data files of issued checks to a central client server 668 rather than transmitting them to the teller terminal. This would then provide the means to access the issued check records from a large number of check issuers nationwide. This capability would not only significantly reduce or eliminate the incidence of cashed check fraud, but would allow third party checks to be truncated at the point of initial presentment 670 while still preserving the processing and legal requirements of the ARP, positive payment applications, and check retention regulations.

While preferred and alternate embodiments have been described herein, it is to be understood that these descriptions are only illustrative and are thus exemplifications of the present invention and shall not be construed as limiting. It is to be expected that others will contemplate differences, which, while different from the foregoing description, do not depart from the true spirit and scope of the present invention herein described and claimed.

What is claimed is:

1. A method of authenticating the payee printed on a negotiable instrument, comprising the steps of:
storing the identification information of the payee in a central computer system thereby creating stored identification information;
recalling said stored identification information; and
affixing said stored identification information on said negotiable instrument thereby creating affixed identification information.

2. The method as claimed in claim 1 further comprising the steps of:
presenting said negotiable instrument for payment;
recalling said stored identification information; and
comparing said stored identification information with said affixed identification information.

3. The method as claimed in claim 1 wherein said identification information contains information to positively identify said payee.

4. The method as claimed in claim 1 wherein said identification information includes a digitized picture of said payee.

5. The method as claimed in claim 1 wherein said identification information includes biometric data of said payee.

6. The method as claimed in claim 1 wherein said affixed identification information contains machine-readable information.

7. The method as claimed in claim 5 wherein said machine-readable information is in magnetic ink character recognition fonts.

8. The method as claimed in claim 5 wherein said machine-readable information is in optical character recognition fonts.

9. The method as claimed in claim 5 wherein said machine-readable information is in bar coded fonts.

10. The method as claimed in claim 1 wherein said affixed identification information further contains additional human-readable issuing bank identifying information selected from the group consisting essentially of icons, logos, telephone numbers, or web site addresses.

11. The method as claimed in claim 2 wherein the step of comparing said stored identification information with said affixed identification information comprises at least one telephone device, said telephone device being in operable connection to a communication network.

12. The method as claimed in claim 10 wherein said telephone device is an audio response activated device.

13. The method as claimed in claim 2 wherein the step of comparing said stored identification information with said affixed identification information comprises at least one scanner device, said scanner device being in operable connection to a communication network.

14. The method as claimed in claim 12 wherein said scanner device is a device selected from the group consisting essentially of a magnetic ink character recognition, a bar code font recognition, and optical character font recognition devices.

15. The method as claimed in claim 12 wherein said scanner device is further in operable connection with a terminal device.

16. The method as claimed in claim 13 wherein said terminal device is capable of transmitting and receiving data to and from the issuing bank check database.

17. The method as claimed in claim 12 wherein said scanner device includes an image capture device capable of generating, storing and transmitting digitized images of the bank check to a database.

18. The method as claimed in claim 13 further comprising a keyboard device, said keyboard device being in operable connection with said terminal and being capable of key entry initiation of computer commands to provide interactive electronic communication access.

19. The method as claimed in claim 13 further comprising a screen display device, said screen display device being in operable connection with said terminal and being capable of displaying images of said stored identification information.
